(19) United States
(12) Patent Application Publication
(10) Pub. No.: US 2007/0060100 A1
(43) Pub. Date: Mar. 15, 2007

(54) Systems and methods for mobile station service control

(75) Inventors: Theodore W. Watler, Long Beach, CA (US); S. Robert Pye, Roswell, GA (US); Chandler Tedholm, Rockaway, NJ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Telemac Corporation, Los Angeles, CA (US)

(21) Appl. No.: 11/227,283

(22) Filed: Sep. 14, 2005

(51) Int. Cl. H04M 11/00

(52) U.S. Cl. 455/406

(57) ABSTRACT

Systems and methods wherein the wireless device operates as a service control point (“SCP”) in a wireless service network. The billing system controls the service control point in the wireless device by periodically supplying increments of value from a master account balance. The billing system may also periodically update the service rules and authorizations maintained within the wireless device. Usage information such as call details records may also periodically be uploaded from the wireless device to the billing system. The service control function software in the wireless device and the billing system communicate with each other via administrative messages using over the air data bearer services of the network. The amount and frequency of the additional service authorizations and other communications vary, potentially on a service by service basis, depending upon the credit risks, fraud risks, user preferences, rate plans, available network resources, and other parameters.

### BACKGROUND OF THE INVENTION

1. Field of the Invention

The present invention generally relates to network access and, more specifically, to managing access to a wireless network through a service control function located on a wireless device, and the relationship of this function to a billing system.

2. Description of the Prior Art

Service control is a fundamental function of telecommunication networks. If the network is to function as a money-earning entity, it is necessary to prevent access by subscribers who have not paid or may not pay for the service. In the early days of wired networks, service control was as simple as physically disconnecting the wires leading to the subscriber's telephone. Wireless networks face a more complicated problem, since any compatible mobile station (MS) within the network coverage area may potentially attempt to access the network. Wireless networks overcome this problem by maintaining a database of valid subscribers (home location register, HLR) and a database of active subscribers and approved subscribers from other networks (visitor location register, VLR). When a subscriber attempts to access a network, their subscriber identity (e.g., IMSI) is validated against the HLR/VLR records. If the identity is found to be valid, the network allows access to proceed. If not, access to the network is denied.

In reality, however, the validity of a subscriber's access depends on the status of their billing account. Therefore, the ultimate arbiter of subscriber access validity is not the network, but the entity that maintains the subscriber's account status, typically the billing system. Furthermore, in today's environment, a subscriber's credit status may change rapidly over time, as prepaid credits are used up or credit limits are reached through billable usage or other purchases. Therefore, the determination of validity is increasingly required to be made in real time.

Before the present invention, implementations of billing required some level of communication between a billing system and the HLR/VLR/SCP (with or without ancillary Intelligent Peripheral “IP” for account rules and/or balances) network elements. The HLR/VLR/SCP network elements were not originally designed for real-time communication with a billing system. Doing so consumes valuable network processing resources that could otherwise be devoted to revenue-generating traffic.

Prior implementations of billing also introduced varying degrees of delay or latency due to the process of the network consulting with the billing system. These delays varied based upon the availability of billing information (e.g., roaming, data, and other services), processing delays, and in some cases were deliberately introduced in order to limit the adverse effects of processing overhead. Some implementations are capable of exerting service control only after a call or other transaction has been completed. Each instance of latency introduced opportunities for the wireless service provider to lose revenue due to unpaid usage.

With technical advances and market competition, wireless service providers are increasingly resorting to complex bundling of pricing plans that include multiple services and subscribers. Complex billing schemes include discounts, limits, and bonus additions of value at an individual, family, business, or group level based upon many factors. These factors include aggregate usage within variable time limits, promotional activity, and many other criteria, some of which are completely independent of the network behavior, These plans may mean that rating rules change dynamically based on actions taken by multiple accounts, further increasing the need for tight integration between the billing system and the service control function.

Prior to the present invention, the typical method for providing real-time service control was an outgrowth of the manner in which post-paid accounts were managed. For post-paid accounts, a billing system external to the network keeps track of a subscriber's expenditures and payment history. When the wireless service provider's business rules determine that the subscriber is no longer entitled to service, the billing system sends a message to the network changing the subscriber's status on the HLR/VLR/SCP records, resulting in denial of future service requests. This method was extended to requirements such as prepaid service by increasing the frequency with which the billing system communicates with the network. However, when the HLR/VLR/SCP is coupled tightly with the billing system, this entails a major drawback in that the additional network processing requirements for real-time or near-real-time communication with the billing system effectively reduces the capacity of the network to support traffic and subscribers compared to a network population of post-paid subscribers. In addition, systems such as this tend to introduce delays (latency) in call set-up that may cause subscriber dissatisfaction. Systems of this nature also may be vulnerable to allowing unpaid traffic (revenue leakage) due to polling intervals or the inability to end calls in progress. By allocating a portion of the master balance, as well as delegating local service control, to the wireless device held by the subscriber, the present invention overcomes these drawbacks and provides real time local service control without the delays or resource consumption required to contact the HLR/VLR/SCP network elements or billing system over the network.

An alternative method utilizes a network feature known as “Advice of Charge.” The Advice of Charge standards define a format for sending the cost information about a call or other transaction to a wireless handset. The Advice of Charge feature has been used to control wireless handset usage, but the implementation has led to significant risks of leakage under a variety of circumstances. This method also subjects the user to potentially inaccurate balance information, and arbitrary limits to the length of certain types of calls. As described in ETSI TS 122 024, Advice of Charge is designed primarily to advise the subscriber of the cost of a call, rather than providing accurate billing and service control. The Advice of Charge standards include the ability to set a maximum amount of consumption, but the subscriber is able to change this maximum. The Advice of Charge feature is also not designed to terminate calls in progress, nor does it include provisions to meter billable traffic other than voice.

Another alternative method involves keeping the account balance in the mobile station and deducting the cost of service as usage occurs based on rating rules stored in the mobile station. While this method avoids the network overhead associated with network-based billing systems, due to storage and processing limitations, it cannot conveniently support certain tariff structures a wireless service provider may wish to offer. These may include structures that require a large database (such as might be required to offer a special rate to all subscribers on a network), structures that involve multiple accounts (such as sharing a pool of credit), or structures involving information otherwise not available to the mobile device. In this case the service control application in the mobile station may be independent of the billing system for indefinite periods of time. By having a centralized rating and balance management function with theoretically unlimited processing and data storage, the present invention overcomes these drawbacks and allows for rating programs that might be impractical for wireless device based rating engines. However, by allocating a portion of the master balance, as well as delegating local service control, to the wireless device held by the subscriber, the present invention does not sacrifice the benefits of a wireless device based system. A major benefit of having a service control function in the wireless device is that the user experiences a quicker connection to the service, because authorization for the service is performed within the wireless device and does not involve the delay required to query a network element and wait for the response.

### SUMMARY OF THE INVENTION

According to one exemplary embodiment of the present invention, a system for managing local control of access to a wireless network includes a wireless device with a processor, memory, and first software code, and a central billing system with a processor, memory and second software code. The first software code is configured to receive messages via the wireless network, wherein each message or a set of messages represents an amount of authorized use. The first software code is also configured to modify a locally stored account by each amount of authorized use received, determine a charge for each use of the wireless device, and modify the locally stored account in real time for each charge determined. The second software code is configured to send the messages via the wireless network representing the amounts of authorized use, and modify a centrally stored account for each amount of authorized use sent. The frequency of sending amounts of authorized use to the wireless device is based upon at least one of a group comprising credit risk, fraud risk, user preferences, rate plans, available network resources, and other criteria. Additionally, the first software code restricts further access to the wireless network, or restricts use of the wireless device, when the balance in the locally stored account is at or below a predetermined amount and there are no additional amounts of authorized use available from the second software code.

According to one exemplary embodiment, the second software code is configured to modify the centrally stored account by an amount representing a payment received or a modification in available credit.

In a further exemplary embodiment, rules and/or data used by the first software code to determine charges for use of the wireless device are different from rules and/or data used by the second software code to determine charges for use of the wireless device.

In one exemplary embodiment, the second software code is configured to send a message, or set of messages, to the first software code to modify the locally stored account balance, when the second software code modifies the centrally stored account based on rules and/or data that differ from those used by the first software code.

In another exemplary embodiment, the second software code is configured to receive data records from the wireless network with information regarding use of the wireless device, determine charges for use of the wireless device based on the data records, and modify the centrally stored account for each charge determined.

In a further exemplary embodiment, the second software code is configured to compare the centrally stored account with the locally stored account and, if different, send a message, or set of messages, to the first software code to modify the locally stored account balance to be equal to the centrally stored account balance.

In yet another exemplary embodiment, the first software code is configured to create data records with information regarding use of the wireless device and communicate the data records to the second software code in messages sent via the wireless network.

In another exemplary embodiment, the messages sent by the first software code to the second software code are SMS messages.

In a further exemplary embodiment, the messages sent by the second software code to the first software code are SMS messages.

In a further exemplary embodiment, the messages sent by the second software code to the first software code are signaling messages.

In yet another exemplary embodiment, the messages sent by the second software code to the first software code are encrypted.

In another exemplary embodiment, the messages sent by the second software code to the first software code include at least one of a group comprising changes to the rates used by the first software code to determine a charge for use of the wireless device, changes to barred telephone numbers, changes to barred websites, changes to allowed telephone numbers, changes to allowed websites, and promotional messages.

In a further exemplary embodiment, the first software code is configured to prevent the wireless device from making any calls except calls to emergency services and calls to a customer service center when the balance in the locally stored account is at or below a predetermined amount and there are no additional amounts of authorized use available from the second software code.

In another exemplary embodiment, the first software code is configured to prevent the wireless device from receiving any calls when the balance in the locally stored account is at or below a predetermined amount and there are no additional amounts of authorized use available from the second software code.

According to yet another exemplary embodiment of the present invention, a method for managing local control of access to a wireless network includes providing a wireless device that includes a processor, memory, and first software code, and providing a central billing system that includes a processor, memory and second software code. The method also includes sending messages via the wireless network from the central billing system to the wireless device, wherein the first software code is configured to receive messages via the wireless network, wherein each message or a set of messages represents an amount of authorized use, and wherein the second software code is configured to send the messages via the wireless network representing the amounts of authorized use. The method also includes modifying, with the first software code, a locally stored account by each amount of authorized use received, and determining, with the first software code, a charge for each use of the wireless device, wherein the locally stored account is modified in real time for each charge determined. Additionally, the method includes modifying, with the second software code, a centrally stored account for each amount of authorized use sent, wherein the frequency of sending amounts of authorized use to the wireless device is based upon at least one of a group comprising credit risk, fraud risk, user preferences, rate plans, available network resources, and other criteria. The first software code restricts further access to the wireless network, or restricts use of the wireless device, when the balance in the locally stored account is at or below a predetermined amount and there are no additional amounts of authorized use available from the second software code.

The present invention thus provides a superior solution for real-time billing. True real-time service control takes place in the wireless handset, acting as an extension of the billing system. With the present invention, service control takes place with no latency and no processing requirement on the part of the network. At the same time, the bulk of rating logic remains under the control of the billing system, allowing complex rating plans involving multiple accounts and services to be offered.

Other features and advantages of the present invention will be apparent in view of the following detailed description of preferred exemplary embodiments.

BRIEF DESCRIPTION OF THE DRAWINGS

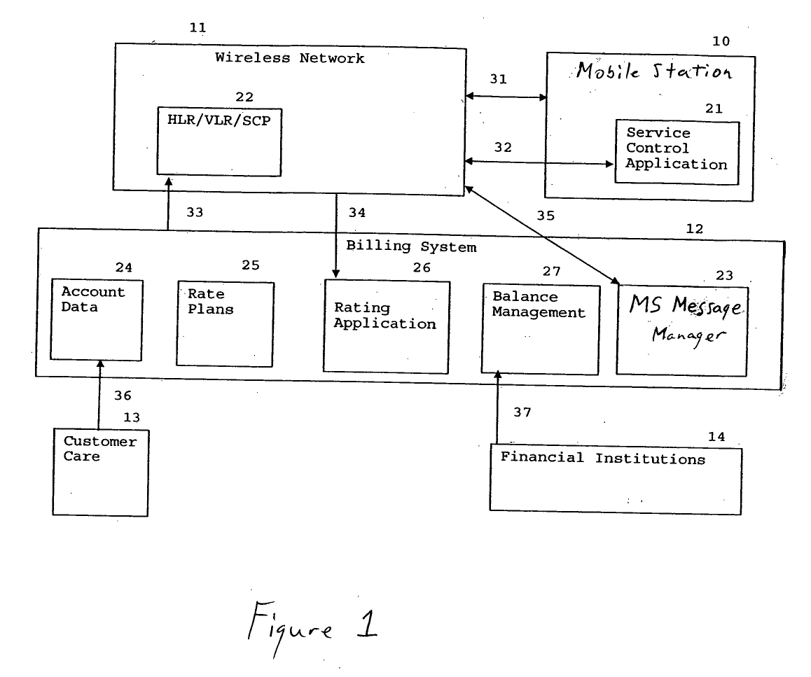

FIG. 1 is a simplified block diagram illustrating an exemplary embodiment of the present invention.

### DETAILED DESCRIPTION OF THE INVENTION

FIG. 1 shows the general arrangement of a Global System for Mobile Communications (GSM) network. Only those elements relevant to the invention have been included. These elements include the mobile station or wireless device 10 belonging to a subscriber, the wireless network 11 connected to other voice and data networks (not shown), a billing system 12, a customer care system 13, and financial institutions 14. While the invention is described in the context of a GSM system, those skilled in the art will understand that such a description does not in any way limit the application of the present invention in any other telecommunications network.

Additionally, for ease of reference, the description refers to the wireless device as being a service control point regardless of whether the software implementing the service control function is operating in the ME environment, or in the subscriber identity module (SIM) or other card environment. As known in the art, the wireless device may function to prevent or terminate wireless services, once the authorization for these services is consumed or expires. The wireless device may also gather billing data and forward that data to a billing system, either through electrical connections or over-the-air.

Within the mobile station 10 is a service control application 21, which is generally software that provides service control functions. The service control application 21 is typically installed on a suitable SIM card, but may alternatively be implemented in the operating environment of the mobile equipment. The service control application 21 may be implemented at the application, operating system, firmware or hardware levels. The service control application 21 stores the service permissions and tariff rating rules applicable to the rate plan assigned to the individual subscriber. The service control application 21 maintains the balance or allowance immediately available to the subscriber. For some rate plans, only a portion of the rating rules may be stored with the service control application 21, possibly requiring the billing system 12 to send an adjustment to the balance maintained by the service control application 21. The balance may be expressed as a monetary value, a number of units, or a combination.

When the mobile station 10 is initially powered up, the service control application 21 instructs the mobile station 10 to notify the service control application 21 of the request for, initiation of, and appropriate intervals of service usage (e.g. each minute of use, each 100 bytes of data, each instance of SMS, etc.) for any relevant voice, data or messaging traffic activity 31 and of any other information the service control application 21 needs to approve or meter such traffic including information requested by the service control application 21 of the ME, network, or other entity. The service control application 21 first determines whether the service is allowed and, if allowed, has sufficient account value to proceed. The service control application 21 then meters voice, data, and messaging traffic activity 31 taking place through the mobile station 10 and computes the consumption of allowance represented by the traffic according to the tariff rating rules in effect for that subscriber. The metering performed by the service control application 21 may be based on measurement of elapsed time, volume of traffic, number of messages, or other method determined by the wireless service provider.

The service control application 21 interacts with the mobile station 10 to prevent traffic that might exceed the available allowance based upon the rules in the service control application 21 at each instance of service usage (e.g., every minute of voice use, every 100 bytes of data traffic, each SMS, every currency value of specialized data or messaging, etc.). Traffic to emergency and service numbers are typically allowed unconditionally. The service control application 21 also receives and decrypts administrative messages 32 sent from the billing system 12 via the wireless network 11. These administrative messages 32 may be short message service (SMS) messages, but other bearer types may be used in some environments (e.g., GPRS, USSD data channel, CDMA EV-DO, and signaling messages). These administrative messages 32 may contain information concerning additional allowance, adjustments of allowance, changes to the rate plan, changes to barred or allowed numbers, and promotional messages.

The service control application 21 may, under some circumstances, initiate administrative messages 32 to the billing system containing balance and call record information. Administrative messages 32 are never visible to or under the control of the subscriber. The service control application also preferably includes a user interface (not represented in FIG. 1), allowing the subscriber, for example, to use the mobile station 10 to view information about the account and the cost of traffic and to initiate certain self-administration actions (e.g., adding a phone number to a no-charge list).

When a subscriber account is initially provisioned, the wireless network 11 receives information about the mobile station 10 from the billing system 12 over a provisioning interface 33. The wireless network stores the information in the databases of the HLR/VLR/SCP network elements 22. Those skilled in the art will understand that the HLR, VLR and SCP (with or without ancillary Intelligent Peripheral “IP” for account rules and/or balances) are separate elements of the network that are referred to collectively in this description for convenience. Subsequent changes in account status, typically infrequent, may also be sent from the billing system 12 to the HLR/VLR/SCP network elements 22 by the provisioning interface 33.

When a request is made to initiate voice, data, or message traffic 31, the wireless network 11 authenticates the validity of access by the mobile station 10 by looking up the status on the databases of the HLR/VLR/SCP network elements 22. Once authenticated, the wireless network 11 provides connectivity for voice, data, and messaging traffic 31 to subscribers within the network or to other networks (not shown). As voice, data and messaging traffic 31 occurs, the wireless network 11 sends information in the form of call detail records to the billing system 12 via the call detail record interface 34.

A billing system 12 supporting the present invention preferably includes a number of subsystems, including a MS message manager 23, account data records 24, rate plan records 25, a rating application 26, and a balance management system 27. Those skilled in the art will understand that the organization of the billing system described here does not in any way limit the application of the present invention to billing systems in which the organization into subsystems differs from the embodiment described here.

For the present invention, the MS message manager 23 is adapted to communicate with the service control application 21. The MS message manager 23 sends and receives messages (such as SMS or signaling messages) through the wireless network 11 to the service control application 21 on the mobile station 10, via a MS message manager interface 35 to the wireless network 11, which in turn communicates with the mobile station 10 over the air via administrative messages 32. The MS message manager 23 performs functions associated with the process of secure communication of the administrative messages 32 such as verification of receipt, retry procedures, sequencing, encryption and other security measures.

The account data records 24 are a repository for subscriber information, transaction history, assigned rate plans, and other relevant information. The account data records 24 provide subscriber information for the customer care system 13 via a customer care interface 36. The customer care system may include multiple options, such as web-based self-care, interactive voice response, and human agents.

The rate plans 25 are a repository for the business rules defining the tariff cost of all permissible types of voice, data, and messaging traffic 31 for each rate plan in effect. These rates may be different depending on destination, time of day, or other factors such as the amount of credit purchased. The rate plans 25 also define discount thresholds, triggering events, and the effect of linked accounts. Rate plans may be defined in monetary terms, in the form of units, or a combination of the two.

The rating application 26 applies the rate plan rules to traffic information in the form of call detail records (CDR) provided by the wireless network 11 via the CDR interface 34. The rating application 26 processes the traffic for each subscriber with the same rating rules that are applied in the service control application 21 in the subscriber's mobile station 10. The rating application 26 may have additional rating rules that are impractical to store with the service control application, in which case the billing system 12 is adapted to recognize the rating application's 26 use of such rating rules and in combination with the balance management 27 functionality to generate and communicate an adjustment to the balance maintained by the service control application 21. Examples of situations where it may be impractical to store rating rules with the service control application include: special rates for calls to any destination on the same network, special rates for a relatively large number of destinations, pooled units among multiple subscribers, and discount thresholds for collective usage among multiple subscribers.

For the present invention, the service control application 21 may also be adapted to create and communicate call detail records (CDR) for one or more services and the rating application 26 may be adapted to also receive such call detail records from the MS message manager 23 receiving administrative messages 32 via the network 11 and MS message manager interface 35. An example of a service for which it may be beneficial for the service control application 21 to create and communicate call detail records (CDR) is a data communication session rated by volume where the volume of successfully received data is best metered at the wireless device. Another example is a game service where rating is based on the amount of time or instances the game is played.

The balance management 27 functionality stores information about the overall master balance of the account, as well as the allowance that is currently stored in the service control application 21. The balance management 27 functionality periodically transfers allowance value from the master balance to the balance maintained in the service control application 21. This transfer takes the form of messages sent through the MS message manager 23, over the MS message manager interface 35, through the wireless network 11, over the air as an administrative message 32 to the mobile station 10, which directs the message to the service control application 21.

The frequency of the interval between balance transfer messages between the balance management 27 functionality and the service control application 21 is a continuum ranging from infrequently (e.g., once a month or longer) to frequently (every few minutes or less). The amount of value transferred may likewise range from relatively large (e.g., $100) to relatively small (less than one dollar). In general, the larger the amount of value transferred, the longer the interval between balance transfers will be.

The frequency and amount of transfer may change dynamically depending upon a multiplicity of factors, including the nature of the account, the creditworthiness of the subscriber, the triggering of discount thresholds, the observed performance of the network, the possibility of fraudulent use, and other factors at the discretion of the one or more wireless service providers. Values may be currency, units of usage, etc. and may be stored in multiple accounts at the service control application 21 (e.g., 100 minutes of voice locally used, 20 minutes of voice internationally used, etc.). Further examples include:

A prepaid customer whose balance was only $10 might receive $1 for immediate use, while one who had a balance of $100 might be trusted with $10.

A new postpaid customer might be allowed a small balance, while an established customer with excellent credit might be allowed a larger balance.

A wireless service provider may wish to issue a retroactive credit for service used because a group of subscribers reaches a certain threshold (such as a tariff structured such that if a family uses up to 1,000 minutes, calls are $0.10 per minute, but 1,000+ calls are $0.08 per minute.

A wireless service provider may wish to transfer larger amounts prior to peak busy hours in order to reduce network overhead during those hours.

A wireless service provider may wish to transfer larger amounts of value if excessive delays in messaging traffic are observed in a given area.

For security reasons, a wireless device user may not want large amounts of cash equivalent or available credit stored on the wireless device.

It can be seen from the above examples that the interaction of business concerns, network operations, customer-initiated events, and changing wireless service provider priorities may create a situation where the amount of value transferred and the interval between transfers may be different from subscriber to subscriber, or for a given subscriber at different times or locations.

The balance manager 27 maintains the rules governing the frequency of balance transfer, and initiates the transfer messages. The balance manager 27 also accepts additions or subtractions to the account balances from external systems here generally represented as financial institutions 14 via the financial institution interface 37. Financial institutions may include the wireless service provider's accounts receivables, as well as banks, credit card companies, and point of sale networks.

If there is no more balance or credit available in the balance manager 27 or the service control application 21, the service control application 21 prevents traffic that might represent a loss of revenue to the wireless service providers. The service control application 21 stops calls and other traffic in progress and prevents further traffic, typically alerting the subscriber through audible tones and display messages on the mobile station 10. In this manner the service control application 21 exercises real-time control under the direction of the billing system. The HLR/VLR/SCP network elements 22 have no direct involvement after the initial authorization of the mobile station 10.

The rating application 26 calculates charges based on call detail records (CDR) from the wireless network. These records are triggered by a variety of events relating to the processing of voice, data and messaging traffic 31. These events are not in every case identical to the events used by the service control application 21 to calculate charges. Due to latencies within the network and other factors, this may lead to differences in timing between the network as reflected by call detail records, and the service control application. Small differences in timing may result in differences in recorded balance.

The balance manager 27 periodically reconciles the difference between the balance maintained by the service control application 21 and the balance maintained by the balance manager 21. The balance manager 27 queries the service control application 21 for balance and call record information, compares this information to the balance and call record information stored in the balance manager, and reconciles the difference by issuing credits or debits to the service control application. These credits or debits take the form of messages sent through the MS message manager 23, over the MS message manager interface 35, through the wireless network 11, and over the air as an administrative message 32 to the mobile station 10, which directs the message to the service control application 21. The rules for the reconciliation are generally determined by the wireless service provider, although normally the record created by the network call detail records are considered the “master” record.

The foregoing descriptions of specific embodiments of the present invention have been presented for purposes of illustration and description. Those skilled in the art will understand that modern wireless networks may have several independent billing systems for regional networks, different services, etc. that may or may not be tightly synchronized. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A system for managing local control of access to a wireless network, the system comprising:
a wireless device with a processor, memory, and first software code; and
a central billing system with a processor, memory and second software code;
wherein the first software code is configured to receive messages via the wireless network, wherein each message or a set of messages represents an amount of authorized use;
wherein the first software code is configured to modify a locally stored account by each amount of authorized use received, determine a charge for each use of the wireless device, and modify the locally stored account in real time for each charge determined;
wherein the second software code is configured to send the messages via the wireless network representing the amounts of authorized use, and modify a centrally stored account for each amount of authorized use sent;
wherein the frequency of sending amounts of authorized use to the wireless device is based upon at least one of a group comprising credit risk, fraud risk, user preferences, rate plans, and available network resources; and
wherein the first software code restricts access to the wireless network, or restricts use of the wireless device, when the balance in the locally stored account is at or below a predetermined amount and there are no additional amounts of authorized use available from the second software code.

2. The system of claim 1 wherein the second software code is configured to modify the centrally stored account by an amount representing a payment received or a modification in available credit.

3. The system of claim 1 wherein rules and/or data used by the first software code to determine charges for use of the wireless device are different from the rules and/or data used by the second software code to determine charges for use of the wireless device.

4. The system of claim 3 wherein the second software code is configured to send a message, or set of messages, to the first software code to modify the locally stored account balance when the second software code modifies the centrally stored account based on rules and/or data that differ from those used by the first software code.

5. The system of claim 1 wherein the second software code is configured to receive data records from the wireless network with information regarding use of the wireless device, determine charges for use of the wireless device based on the data records, and modify the centrally stored account for each charge determined.

6. The system of claim 5 wherein the second software code is configured to compare the centrally stored account with the locally stored account and, if different, send a message, or set of messages, to the first software code to modify the locally stored account balance to be equal to the centrally stored account balance.

7. The system of claim 1 wherein the first software code is configured to create data records with information regarding use of the wireless device and communicate the data records to the second software code in messages sent via the wireless network.

8. The system of claim 7 wherein the messages sent by the first software code to the second software code are SMS messages.

9. The system of claim 1 wherein the messages sent by the second software code to the first software code are SMS messages.

10. The system of claim 1 wherein the messages sent by the second software code to the first software code are signaling messages.

11. The system of claim 1 wherein the messages sent by the second software code to the first software code are encrypted.

12. The system of claim 1 wherein the messages sent by the second software code to the first software code include at least one of a group comprising changes to the rates used by the first software code to determine a charge for use of the wireless device, changes to barred telephone numbers, changes to barred websites, changes to allowed telephone numbers, changes to allowed websites, and promotional messages.

13. The system of claim 1 wherein the first software code is configured to prevent the wireless device from making any calls except calls to emergency services and calls to a customer service center when the balance in the locally stored account is at or below a predetermined amount and there are no additional amounts of authorized use available from the second software code.

14. The system of claim 13 wherein the first software code is configured to prevent the wireless device from receiving any calls when the balance in the locally stored account is at or below a predetermined amount and there are no additional amounts of authorized use available from the second software code.

15. A method for managing local control of access to a wireless network, the method comprising:
providing a wireless device that includes a processor, memory, and first software code;
providing a central billing system that includes a processor, memory and second software code;
sending messages via the wireless network from the central billing system to the wireless device, wherein the first software code is configured to receive messages via the wireless network, wherein each message or a set of messages represents an amount of authorized use, and wherein the second software code is configured to send the messages via the wireless network representing the amounts of authorized use;
modifying, with the first software code, a locally stored account by each amount of authorized use received;
determining, with the first software code, a charge for each use of the wireless device;
modifying, with the first software code, the locally stored account in real time for each charge determined; and
modifying, with the second software code, a centrally stored account for each amount of authorized use sent;
wherein the frequency of sending amounts of authorized use to the wireless device is based upon at least one of a group comprising credit risk, fraud risk, user preferences, rate plans, and available network resources; and
wherein the first software code restricts further access to the wireless network, or restricts use of the wireless device, when the balance in the locally stored account is at or below a predetermined amount and there are no additional amounts of authorized use available from the second software code.

16. The method of claim 15 wherein the second software code modifies the centrally stored account by an amount representing a payment received or a modification in available credit.

17. The method of claim 15 wherein rules and/or data are used by the first software code to determine charges for use of the wireless device that are different from rules and/or data used by the second software code to determine charges for use of the wireless device.

18. The method of claim 17 further comprising the second software code sending a message, or set of messages, to the first software code to modify the locally stored account balance when the second software code modifies the centrally stored account based on rules and/or data that differ from those used by the first software code.

19. The method of claim 15 further comprising the second software code receiving data records from the wireless network with information regarding use of the wireless device, determining charges for use of the wireless device based on the data records, and modifying the centrally stored account for each charge determined.

20. The method of claim 19 further comprising the second software code comparing the centrally stored account with the locally stored account and, if different, sending a message, or set of messages, to the first software code to modify the locally stored account balance to be equal to the centrally stored account balance.

21. The method of claim 15 further comprising the first software code creating data records with information regarding use of the wireless device and communicating the data records to the second software code in messages sent via the wireless network.

22. The method of claim 21 wherein the messages sent by the first software code to the second software code are SMS messages.

23. The method of claim 15 wherein the messages sent by the second software code to the first software code are SMS messages.

24. The method of claim 15 wherein the messages sent by the second software code to the first software code are signaling messages.

25. The method of claim 15 wherein the messages sent by the second software code to the first software code are encrypted.

26. The method of claim 15 wherein the messages sent by the second software code to the first software code includes at least one of a group comprising changes to the rates used by the first software code to determine a charge for use of the wireless device, changes to barred telephone numbers, changes to barred websites, changes to allowed telephone numbers, changes to allowed websites, and promotional messages.

27. The method of claim 15 further comprising the first software code preventing the wireless device from making any calls except calls to emergency services and calls to a customer service center when the balance in the locally stored account is at or below a predetermined amount and there are no additional amounts of authorized use available from the second software code.

28. The method of claim 27 further comprising the first software code preventing the wireless device from receiving any calls when the balance in the locally stored account is at or below a predetermined amount and there are no additional amounts of authorized use available from the second software code.
